(19) United States
(12) Patent Application Publication
(10) Pub. No.: US 2005/0273711 A1
(43) Pub. Date: Dec. 8, 2005

(54) System and method for preparing distributable multimedia presentations

(76) Inventors: Diane M. Herzman, Bronxville, NY (US); George Gaunt, Mahopac, NY (US)

Correspondence Address: OSTROLENK FABER GERB & SOFFEN, 1180 AVENUE OF THE AMERICAS, NEW YORK, NY, 100368403, US

(21) Appl. No.: 11/145,915

(22) Filed: Jun. 6, 2005

Related U.S. Application Data
(60) Provisional application No. 60/577,016, filed on Jun. 4, 2004.

(51) Int. Cl. G06F 17/21

(52) U.S. Cl. 715/522; 715/523; 715/542

(57) ABSTRACT

The present invention provides a method for providing a multimedia presentation that includes defining a first multimedia presentation comprising text and audio components, wherein the first presentation has a first file size and is viewable using a first presentation software application. The method further includes isolating the text and audio components included in the first multimedia presentation. The method further includes defining a second multimedia presentation and providing the isolated text and audio components into the second multimedia presentation. Furthermore, the method includes transmitting a message to a recipient that enables the recipient to access the second multimedia presentation. The second multimedia presentation is preferably accessible using web browser software and/or e-mail software, and the second multimedia presentation appears substantially the same as the first presentation file. Furthermore, the second multimedia presentation has a smaller file size than the first multimedia presentation file.

### CROSS-REFERENCE TO RELATED APPLICATIONS

The present invention is based on and claims priority to U.S. Provisional Patent Application Ser. No. 60/577,016, filed on Jun. 4, 2004 and entitled “SYSTEM AND METHOD FOR DISTRIBUTING MULTIMEDIA PRESENTATIONS OVER THE INTERNET,” the entire contents of which are incorporated by reference.

### BACKGROUND OF THE INVENTION

1. Field of the Invention

The present patent application is related, generally, to digital multimedia creations, and, more particularly, to a tool for providing multimedia content over a communication network, such as the Internet.

2. Description of the Related Art

As the number of people communicating over a publicly accessible communication network, such as the Internet, continues to grow, the number of transmissions of large files containing formatted information, such as formal presentations and other formatted works, proportionally grows as well. Millions of people have various needs for transmitting multimedia presentation files that contain elaborate formatting of information in order to capture the attention of recipients or individuals viewing the files.

In the prior art, digital presentations, such as those formatted in MICROSOFT POWERPOINT, are often posted on an Internet web site and, thereafter, downloaded by a user to a local computer system. POWERPOINT is an established and well-recognized tool for making digital presentations. POWERPOINT is useful for presenting information in an organized and visually appealing format, and is generally accepted as a contributor to making sales, preparing a workforce, or advising users about strategy decisions.

It is believed by the inventors that presentations which do not contain moving image and/or audio data are quickly forgotten. One reason may be that many people remember what they see and hear, and not so often what they read. Currently, MICROSOFT POWERPOINT presentations can be formatted to include still images, audio, animation and/or video material. However, inclusion of such objects causes POWERPOINT presentations to grow significantly in byte size. Although the number of Internet users with broadband Internet access (e.g., DSL and cable access) continues to grow, the majority of people still access the Internet via dial-up Internet connections at much slower speeds than those provided by broadband connections. Large presentation files, such as described above, can delay the process of downloading significantly, especially for those users accessing the Internet via dial-up connection.

Also, posting presentations with extensive formatting on a web site can be inconvenient for parties trying to access the files. Often, users must navigate a potentially complex and confusing Internet web site in order to locate and then download a sizable POWERPOINT presentation (or other presentation file). Also, typically the computer system that receives the presentation must be equipped with a particular software application, such as POWERPOINT, in order to view the presentation.

Furthermore, web sites that post presentations typically require personal registration information, such as demographics information, business-related information and other information received from the visitor which is often viewed as unduly intrusive. Also, user ID's and passwords can be difficult to recall, thereby increasing the likelihood that a user will not access the presentation. It is believed by the inventors that speed is a significant feature demanded by many people. People have no patience to wade through superfluous and unnecessary information, or endure a nuisance associated with registering and remembering account information on a web site.

Referring to the drawing figures, in which like reference numerals represent like elements, there is shown in FIG. 1 a block diagram that illustrates the increased size of a prior art presentation file as multimedia content is added thereto. In the example shown in FIG. 1, an initial presentation file 2 is provided that includes graphics and text, and is sized accordingly. Presentation file 4 is sized larger than presentation file 2, due to the addition of animation material to presentation file 2. Presentation file 6 is yet even larger than file 4, due to the addition of audio material and animation. Thus, as graphically represented in FIG. 1, prior art presentation files, particularly those formatted in POWERPOINT, grow substantially with the addition of various forms of multimedia content.

One problem associated with large file sizes, such as POWERPOINT presentations that are distributed via e-mail, regards limitations in storage space. Many e-mail service providers restrict the amount of storage that is available for holders of e-mail accounts. For example, a provider restricts the maximum amount of storage for an e-mail account to five megabytes. A MICROSOFT POWERPOINT presentation that includes digital audio and video content can easily exceed such a restriction. A party who attempts to e-mail a large presentation file to a holder of such an e-mail account would be unsuccessful because the e-mail server would refuse the e-mail on the grounds of its size. Thus, parties attempting to e-mail important information may be unable to do so. Moreover, in the event that a user's in-box can accommodate a sizable e-mail (caused, for example, by a large POWERPOINT file), other (potentially unrelated) e-mail messages may, thereafter, be rejected by the e-mail service provider.

Although POWERPOINT presentations can be developed relatively easily, various limitations exist beyond the file size-related issues, described above, and are now described, below.

In order to view a POWERPOINT presentation file, a software application (e.g., the POWERPOINT viewer) must be installed on any PC (or MACINTOSH) computer that does not have a copy of MICROSOFT POWERPOINT installed. Since the price of POWERPOINT is often prohibitive for many computer users, particularly students, an alternative application such as the POWERPOINT viewer is necessary to view the presentation file. The currently available version of the POWERPOINT viewer supports presentations formatted for versions of MICROSOFT POWERPOINT 97 and later, thereby raising the issue, described above, with respect to the version of POWERPOINT with which a particular presentation is created. Another shortcoming of the POWERPOINT viewer is that it is almost two megabytes in size, which may be prohibitive for downloading for users of slow (e.g., dial-up) Internet connections.

Moreover, users are reluctant to download and install anything on their computers due to the outbreak of viruses. POWERPOINT has been known to be vulnerable to virus attacks. MICROSOFT has posted on its Internet web site antivirus technical support specifically for POWERPOINT presentations. Thus, there is a concern among computer users that POWERPOINT presentation files may be infected with a malicious virus.

MICROSOFT POWERPOINT inherently assigns audio content to take precedence over animation. Thus, embedded sounds (e.g., narration) can result in a presentation that has all narration on a slide that is presented first, then a slide containing the animation may appear, thereafter. The ability to integrate sound and animation in a single slide is problematic.

Another shortcoming is that POWERPOINT is not retro-convertible. For example, animation is not processed the same way in various POWERPOINT versions, and, therefore, presentations may behave differently depending upon the particular version of the POWERPOINT a user has installed.

Moreover, a sender of a POWERPOINT presentation would have to know the status of a recipient's computer, i.e. PC with/without POWERPOINT installed, the version of POWERPOINT installed in the recipient's computer, whether the recipient is using a MAC, or the like.

Commercial “POWERPOINT to Flash converter” programs were tested and found unacceptable. For example, a product made by a company, “ARTICULATE” was tested. Although the program converted a “static” POWERPOINT presentation to MACROMEDIA FLASH, it did not accommodate voice/animation coordination. Another distinct drawback was that any converted file is stored on a computer system provided by ARTICULATE, and a small fee is charged for the storage. Charging fees for storing converted FLASH files on a computer system is undesirable.

“BREEZE”, a relatively new and expensive software program, attempts to make inroads in converting POWER POINT into a universally read format, but has limitations and does not function to enable the transfer of multimedia presentations in accordance with the teachings herein.

As will become apparent to one skilled in the art, MACROMEDIA FLASH is computer software for creating, viewing and playing animation, sound, graphics, presentations, and illustrations, typically for the distribution over the Internet. As noted above with respect to POWERPOINT, however, a variety of limitations and/or shortfalls have been identified in FLASH which prevent the inventors from using FLASH exclusively for providing the present invention. Some of these limitations are now described, below.

The time required to assemble a presentation is cost prohibitive. Unlike POWERPOINT, assembling a presentation in FLASH can be extremely time consuming.

Narration cannot be embedded as can be available in POWERPOINT. Instead, separate .MP3 files are used.

Revisions to a FLASH presentation can be extremely time consuming and are often difficult to implement. It is believed that, generally, revisions to a FLASH presentation are far more cumbersome than similar revisions made in POWERPOINT.

### SUMMARY OF THE INVENTION

A need exists for a tool that highlights and displays personal achievements and professional accomplishments. Currently, it is estimated that in today's job market over nine hundred job applicants can compete for a single job. A challenge for each applicant is to create a new and distinctive way to present oneself. Job résumés remain a very common tool for providing information about a job candidate. It is believed, however, that résumés fail to provide a distinctive presentation, especially for an administrator who has the daunting task of reviewing over nine hundred resumes for a single job position.

A need also exists that sets one job candidate apart from the hundreds, if not thousands, of other candidates when competing for a specific job. The present invention comprises a multimedia presentation tool that provides speedy delivery, manageable file size, and platform independence e.g., to accommodate PC and Mac users.

The present invention provides a method for providing a multimedia presentation that includes defining a first multimedia presentation comprising text and audio components, wherein the first presentation has a first file size and is viewable using a first presentation software application. The method further includes isolating the text and audio components included in the first multimedia presentation. The method further includes defining a second multimedia presentation and providing the isolated text and audio components into the second multimedia presentation. Furthermore, the method includes transmitting a message to a recipient that enables the recipient to access the second multimedia presentation. The second multimedia presentation is preferably accessible using web browser software and/or e-mail software, and the second multimedia presentation appears substantially the same as the first presentation file. Furthermore, the second multimedia presentation has a smaller file size than the first multimedia presentation file.

### BRIEF DESCRIPTION OF THE DRAWINGS

FIG. 1 is a block diagram that illustrates an increase in size of a prior art presentation file as multimedia content is added thereto;

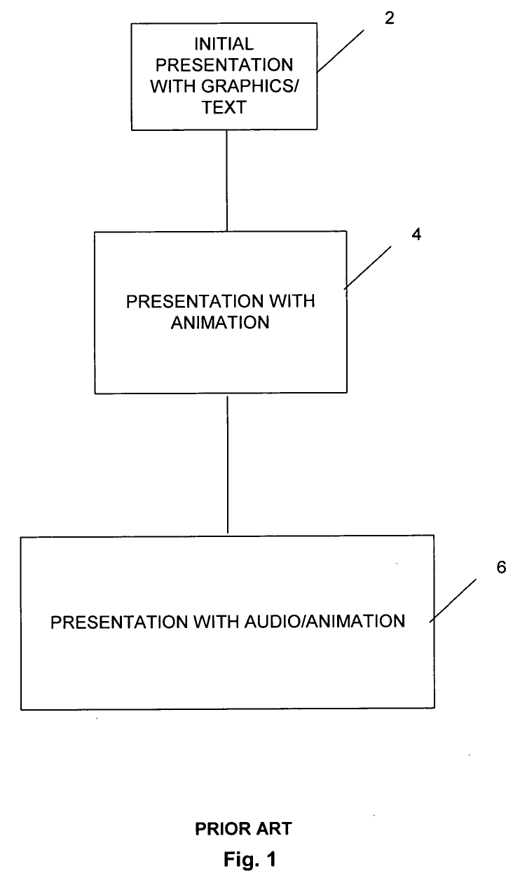

FIG. 2 illustrates an example hardware arrangement in accordance with transmitting presentation files over a communication network;

FIG. 3 is a block diagram illustrating the functional elements in an example information processor;

FIG. 4 is a block diagram that represents a decrease in overall file size by removing components from a POWERPOINT presentation file and adding the components to a FLASH presentation file

FIG. 5 is a flow chart that illustrates steps associated with preparing a demonstration and final presentation file in accordance with a client's specifications;

FIG. 6A is a flow chart that illustrates steps associated with preparing a presentation in MICROSOFT POWERPOINT; and

FIG. 6B is a flow chart that illustrates steps in accordance with an embodiment of the present invention, associated with converting a presentation formatted in MICROSOFT POWERPOINT to MACROMEDIA FLASH.

### DESCRIPTION OF THE INVENTION

The present invention provides an improved system and method for formatting multimedia digital presentations that, preferably, are operable in a variety of computing hardware and software platforms. More particularly, the presentations provided by the present invention employ sight and sound that are designed to impress the viewer and ensure that the viewer keeps the subject of the presentation in memory. The present invention preferably also provides a new business model that includes generating revenue by providing cross-platform multimedia presentations in a convenient Internet web site interface.

The present invention provides a new, powerful digital marketing tool in today's world of instant communication that is flexible, efficient, and is relatively small in size. In an embodiment, the present invention is distributed via e-mail and/or via an Internet web site. As described in detail below, presentations provided by the present invention are preferably reformatted from an initial large, prohibitive size to a smaller and more manageable size. Further, the presentations are designed to be relatively short, for example at most 60 seconds.

Through extensive research, the inventors have combined and adapted features of prior art computer software in order to produce the presentation tool of the present invention. The resulting invention has multiple applications, for example, job résumés, business marketing and for dispersing formatted information. More particularly, the present invention provides a method to deliver multimedia messages in an interesting audio-visual way, and also within a short, e.g., 60 seconds time period. Moreover, the invention preferably utilizes sophisticated tracking to gather data to help users or decision makers make timely decisions. Yet another feature of the present invention includes a flexible medium that maximizes transmission speed of and quantity of information, all of which are considered key benefits that distinguish the invention from the prior art.

In example embodiments, the present invention is applicable for providing résumés in electronic form, to showcase businesses or new business developments, to highlight designs, new products, portfolios, architectural schematics, and/or to aid in job-seeking and recruitment. Other example embodiments of the invention include portfolio displays and design presentations that showcase lighting, fashion, typefaces, landscaping, structural design, color, architectural or engineering feats, interior design, sculpture, art, photography, graphics, and for theatrical experience.

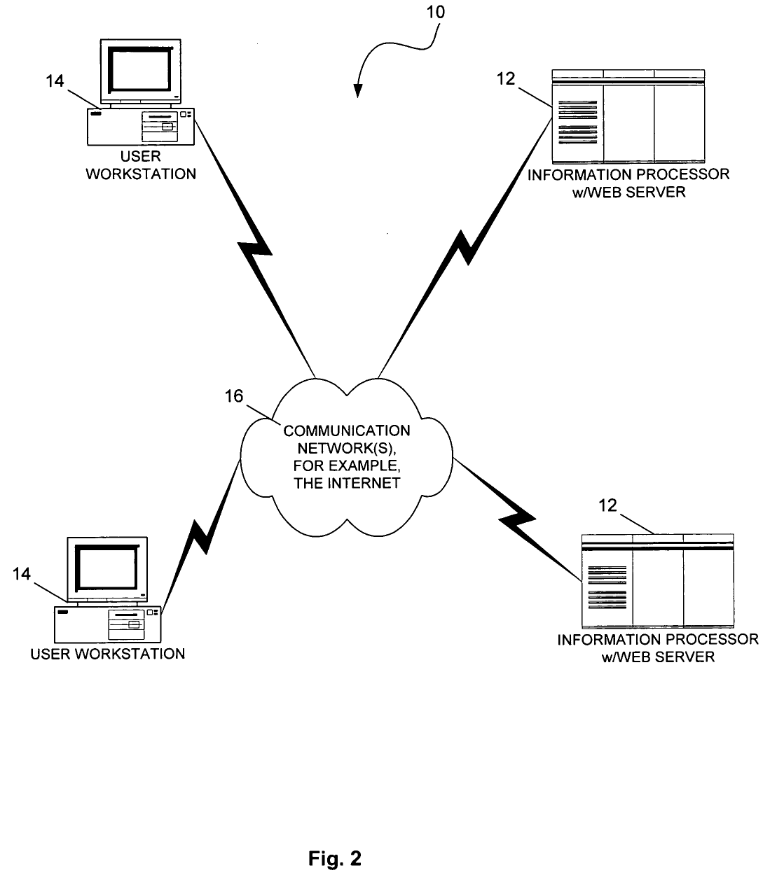

FIG. 2 illustrates an example hardware arrangement, in accordance with an embodiment of the present invention, for transmitting presentation file over a communication network, and referred herein, generally, as system 10. In the example shown in FIG. 2, information processor(s) 12 are operable to function as Internet web servers, as known to those skilled in the art.

Information processor 12 preferably includes all databases necessary to support the present invention. However, it is contemplated that information processor 12 can access any required database via communication network 16 or any other communication network to which information processor 12 may be coupled. Communication network 16 is preferably a global public communication network such as the Internet, but can also be a wide area network (WAN), local area network (LAN), or other network that enables two or more computers to communicate with each other.

In a preferred embodiment, information processor 12 and user workstation 14 are any devices that are capable of sending and receiving data across communication network 16, e.g., mainframe computers, mini computers, personal computers, laptop computers, a personal digital assistants (PDA) and Internet access devices such as Web TV. In addition, information processors 12 and user workstations 14 are preferably equipped with web browser software, such as MICROSOFT INTERNET EXPLORER, MOZILLA FIREFOX, or the like. Information processors 12 and user workstations 14 are coupled to communication network 16 using any known data communication networking technology.

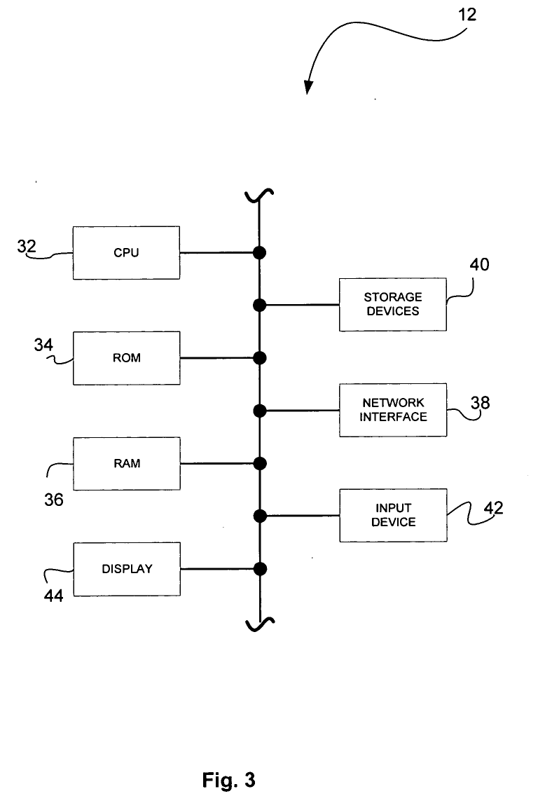

FIG. 3 illustrates the functional elements of an example information processor 12, and includes one or more central processing units (CPU) 32 used to execute software code and control the operation of information processor 12. Other elements include read-only memory (ROM) 34, random access memory (RAM) 36, one or more network interfaces 38 to transmit and receive data to and from other computing devices across a communication network, storage devices 40 such as a hard disk drive, floppy disk drive, tape drive, CD ROM or DVD for storing program code databases and application data, one or more input devices 42 such as a keyboard, mouse, track ball, microphone and the like, and a display 44.

The various components of information processor 12 need not be physically contained within the same chassis or even located in a single location. For example, storage device 40 may be located at a site which is remote from the remaining elements of information processor 12, and may even be connected to CPU 32 across communication network 16 via network interface 38. Information processor 12 preferably includes a memory equipped with sufficient storage to provide the necessary databases, forums, and other community services as well as acting as a web server for communicating hypertext markup language (HTML), Java applets, Active-X control programs or the like to user workstations 14. Information processors 12 are arranged with components, for example, those shown in FIG. 3, suitable for the expected operating environment of information processor 12. The CPU(s) 32, network interface(s) 38 and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within a web browser software display. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of information processor 12 shown in FIG. 3 are of the same categories of functional elements present in user workstations 14. However, not all elements need be present in the user workstation 14. For example, storage devices, in the case of PDA's, and the capacities of the various elements are arranged to accommodate the expected user demand. For example, CPU 32 in user workstation 14 may be a smaller capacity CPU than the CPU present in the information processor 12. Similarly, it is likely that the information processor 12 will include storage devices of a much higher capacity than storage devices present in user workstation 14. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although the present invention is described by way of example herein and in terms of a web-based system using web browsers and a web site server (e.g., information processor 12), system 10 is not limited to such a configuration. It is contemplated that system 10 is arranged such that user workstation 14 communicates with and displays data received from information processor 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 12 and user workstation 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on information processor 12 and user workstation 14 regard the process of communicating data across communication network 16 and processing the data such that the data is viewed on a display 44, for example by using a web browser and the like. As is common with web browsing software, the display 44 on user workstation 14 presents sites within the system 10 such that a user can proceed from site to site within the system by selecting a desired link.

Therefore, each user's experience with system 10 is based on the order with which he/she progresses through the display screens. Graphic controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 10.

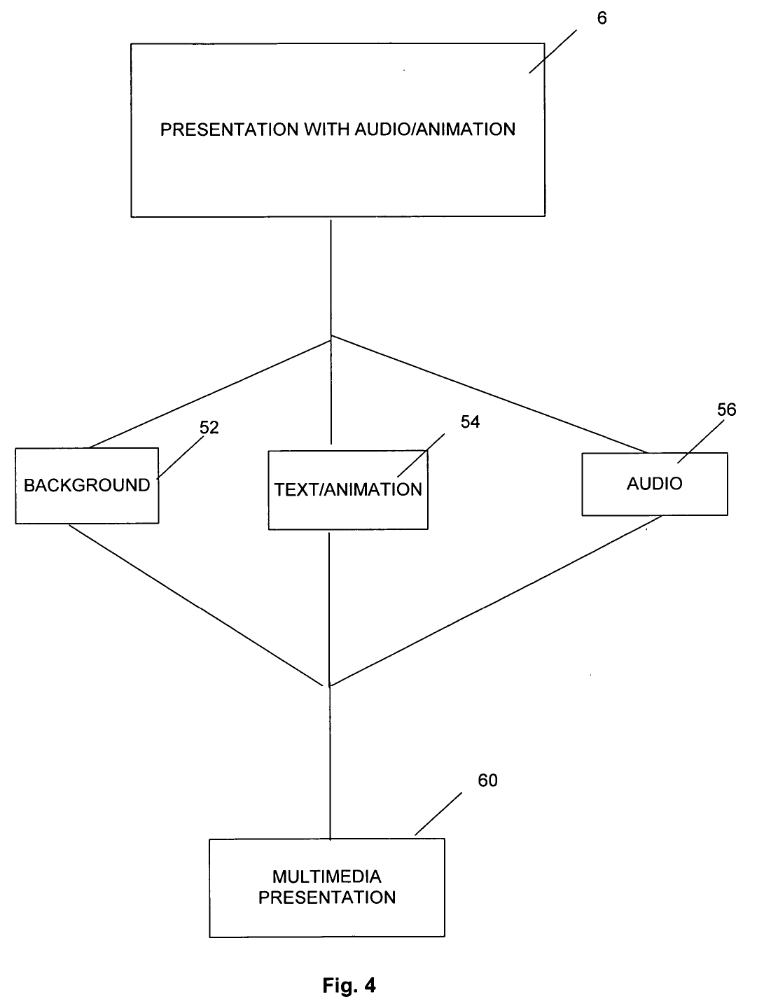

FIG. 4 is a block diagram that represents a decrease in overall file size of a multimedia presentation file by removing components from a presentation file provided in a first format, for example, POWERPOINT, and adding the components to a presentation file, provided in a second format, for example FLASH, in accordance with a preferred embodiment of the present invention. As shown in FIG. 4, prior art presentation file 6 has background material 52, text/animation material 54 and audio material 56 extracted therefrom and incorporated into revised multimedia presentation 60. As graphically represented in FIG. 4, multimedia presentation 60 is significantly smaller in size than prior art presentation 6. Techniques for providing multimedia presentation file 60 at a reduced size (vis-á-vis presentation file 6) are described in detail below.

As used herein, the term, “trailer,” generally, refers to an audio-visual clip that is provided in addition to multimedia presentation 60 provided by the present invention. In a preferred embodiment, a trailer is at most 60 seconds long (preferably, between 30-40 seconds) and is presented substantially automatically when multimedia presentation 60 of the present invention concludes. Alternatively, a trailer is played when an appropriate hyperlink is selected by the user. In yet another alternative embodiment, a trailer is provided to a user who connects to a respective Internet web site. The web site may be provided to the user automatically upon completion of multimedia presentation 60, or in response to the user's selection of a hyperlink.

In an example embodiment of the present invention, an e-mail or other message is transmitted that includes a brief description of a candidate for a job position. The recipient receives an immediate, personal impression of the person described therein. For example, the recipient is a job recruiter and knows the name of the candidate's school, the individual, year of graduation and some information about the applicant from the e-mail message. If there is interest, multimedia presentation 60 may be downloaded, and/or an interview may be arranged. The invention effectively eliminates piles of paper and provides an unique tool to compare “equal” candidates for special positions.

It is believed by the inventors that students generally do not attend job fairs or read expensive school ads. Instead, students check their school's career development web page regularly to receive information regarding employment possibilities. The present invention operates on a digital platform and is, therefore, attractive to contemporary student bodies.

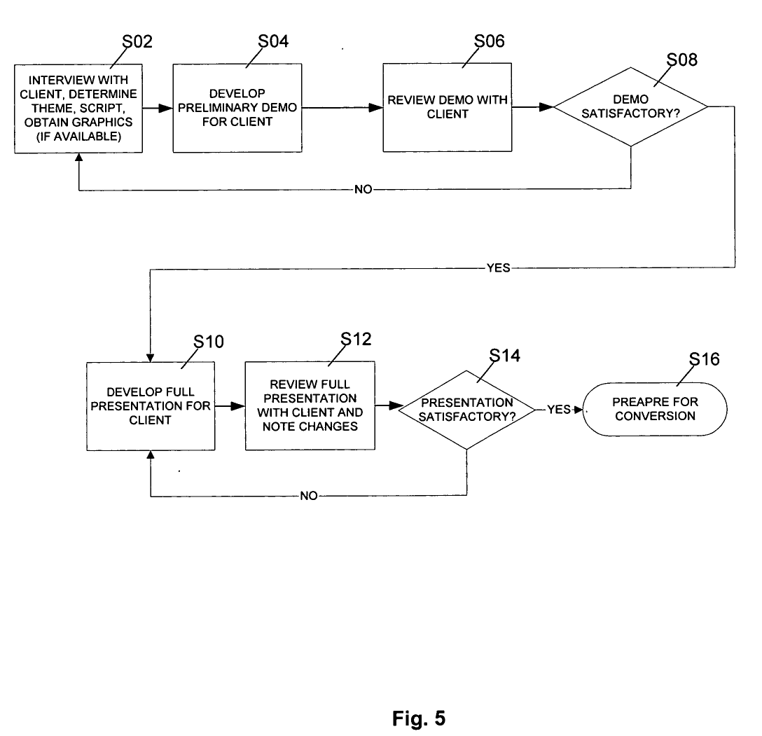

FIG. 5 is a flow chart that illustrates steps associated with preparing a demonstration and final presentation file in accordance with a client's specifications. The example flow chart shown in FIG. 5 includes steps associated with preparing a distributable multimedia presentation prior to converting the presentation from POWERPOINT to FLASH.

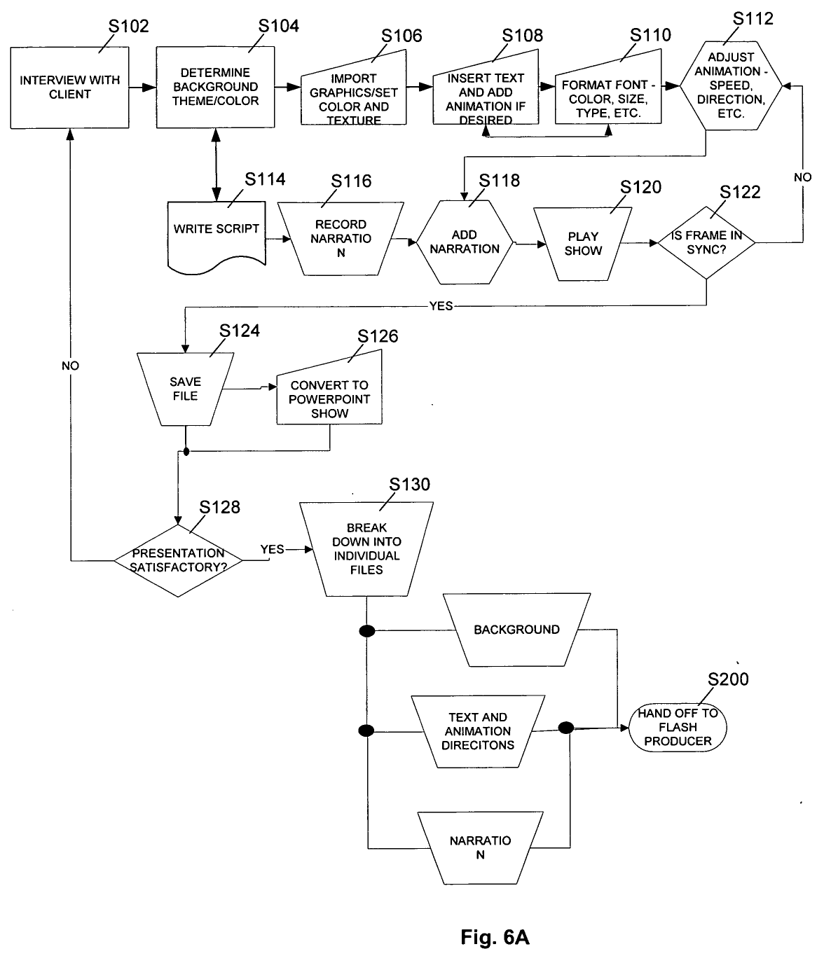

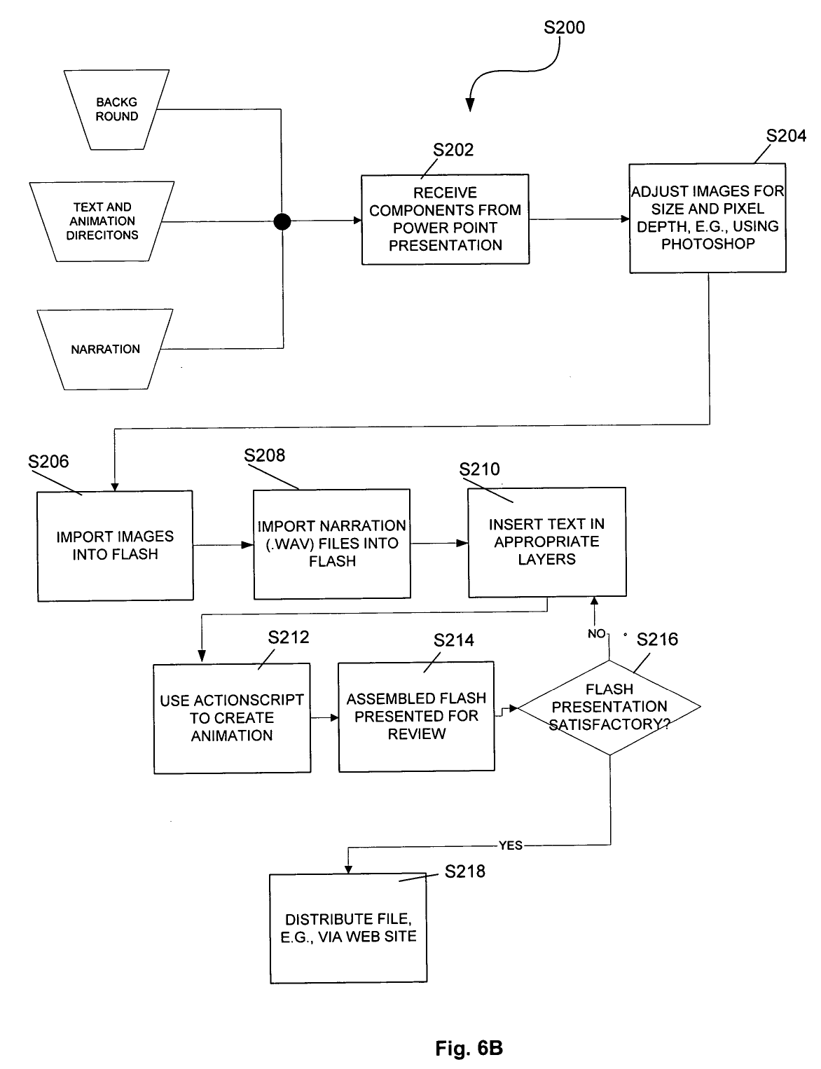

With reference to FIG. 5, in step S02 a client is interviewed and a theme and script is preferably determined. Further, graphics, if available, are obtained. In step S04, a preliminary demonstration (“demo”) is developed, and reviewed (S06) with the client. A determination is made, in S08, if the demo is satisfactory, and, if not, the process loops back to step S02. If the demo is satisfactory, then, in step S10, a full demonstration, preferably provided in MICROSOFT POWERPOINT, is developed for the client. Thereafter, the full demonstration is reviewed with the client and changes, if necessary, are noted (step S12). If, in step S14, it is determined that the presentation is not satisfactory, then the process loops back to step S10. Otherwise, the process ends at step S16, and the full presentation is prepared for conversion. Details regarding converting the presentation are described below, with reference to FIGS. 6A and 6B.

FIG. 6A is a flow chart showing steps for preparing multimedia presentation 60, initially by using POWERPOINT, in accordance with an example embodiment of the present invention.

The steps identified in FIG. 6A include choosing options to be included in the final multimedia presentation 60. For example, in step S102, a user is interviewed to extract information about the *user and the type of presentation the user desires. In step S104-S112, various preferences, such as background colors, textures, text and animation, font type, and various animation options are selected. In steps S114-S118, a script is developed which is read and incorporated into the POWERPOINT presentation. After the script is written and read into a narration, the narration is added to the presentation (step S118). Thereafter, the presentation is played and evaluated to determine whether the frames are in sync (step S120-S122). If, in step S122, it is determined that the frames are not in sync, the process loops back to step S112 and the animation is adjusted to rectify the sync problems. If, in step S122, the frames are deemed in sync, then the file is saved (S124), and the file is converted into a POWERPOINT SHOW (S126). Further, in steps S128, a determination is made whether the presentation is satisfactory. If not, then the process loops back to step S102 where the interview process resumes in order to adjust the presentation to the user's preferences. If in step S128, it is determined the presentation is satisfactory, then the MICROSOFT POWERPOINT presentation file is broken down into individual files (step S130) including, for example, a background text and animation directions and narration. Thereafter, steps associated with converting the POWERPOINT presentation file to a MACROMEDIA FLASH file proceeds (step S200).

FIG. 6B illustrates steps associated with an example embodiment of the present invention in which the above-described POWERPOINT presentation file is processed to be a platform independent multimedia presentation 60, and accommodating the features included in the original presentation file. For example, components 52, 54 and 56 (FIG. 4), included from the POWERPOINT presentation, are received in step S202. In step S204, a third party software application, such as ADOBE PHOTOSHOP, is used to adjust the images for size and pixel depth. In step S206, the images are imported into MACROMEDIA FLASH. In step S208, the narration (formatted as .WAV files) is imported into FLASH. In step S210, text is inserted into appropriate FLASH layers. In step S212, action script is used to create an animation. In step S214, the FLASH presenter is assembled for review. At that point, a determination is made in step S216 whether the FLASH presentation is satisfactory. If not, the process loops back to step S210 and the FLASH presentation is modified. If the presentation is satisfactory, then the process proceeds to step S218 and the file is posted to a web site for review and download by various parties.

Thus, in accordance with steps associated with an example embodiment and shown in FIGS. 5, 6A and 6B, a platform dependent, large-sized presentation that requires MICROSOFT POWERPOINT or a compatible player application is converted to a platform independent, small-sized multimedia presentation 60 that is viewable using web browser software.

The present invention enables the sender to select best works and showcase strengths. The following represents steps associated with an example embodiment of the present invention. A user connects to information processor 12 (preferably functioning as an Internet web server) and submits a data entry form in order to describe a message the user would like to transmit. During this period, decisions are made regarding the use of multimedia material, contact information, or the like. For example, a decision is made whether there should be a single message or multiple messages, or the like. During this decision-making period, the user determines a particular strategy regarding which materials to transmit in order to best showcase his/her strengths.

For example, the user decides if a brochure should be developed from the completed multimedia presentation 60 provided by the present invention to use as handouts. In one embodiment of the present invention, one or more portions of multimedia presentation 60 can be identified for inclusion in additional materials, such as a brochure. In this way, the invention provides, redundancies are avoided such that an on-line communication session with information processor 12 results in production of multimedia presentations 60, as well as other materials.

Another feature of the present invention regards tracking, such as for criteria to be used in multimedia presentation 60 and frequency of reports. Preferably, the present invention evaluates whether a user wants exclusive tracking, which, for example, enables him/her to determine whether multimedia presentations are received and/or viewed, identification of recipients, or the like. Further, particular features to be included in multimedia presentation 60 are preferably selected by the user via graphic screen controls provided in an Internet web site via information processor 12.

Preferably, a contact page is provided that identifies choices made by a user whether to contain trailers, whether to include tracking, whether to transmit automatic e-mail messages to one or more recipients, or the like. Moreover, a plurality drafts (depending on size of the assignment), including script, are submitted to the user for revisions and approval.

After a script is approved, it is preferably read and recorded. The final audio-visual the present invention is transferred to a FLASH format. In a preferred embodiment, the user receives a package, such as a formal binder that includes the script and digital multimedia presentation on a disk (e.g., a CD) which can be e-mailed by the user to one or more recipients. Thereafter, the multimedia presentation is transmitted to a web site (e.g., college career development section) of his/her choice.

In one alternative embodiment, a personalized web address is provided to the user for a period of time, such as one year, for a nominal charge. This feature may be particularly useful for those who do not have a personal web site or web address, or for companies that want to take advantage of immediate access (e.g., www.thepresentinvention.com/USMC).

Thus, the present invention includes a novel business model that enables users to disseminate multimedia presentations conveniently and quickly over the Internet.

The following represents an example process for creating a digital presentation in accordance with the present invention.
1. The design, layout, animation, narration and timing are initially prepared in MICROSOFT POWERPOINT.
2. After final approval, the script is narrated professionally in a sound studio into .MP3 files.
3. The POWERPOINT presentation is broken down to its basic components. Each slide—starting with background, then to script, animation, sound—are delivered separately and recreated in FLASH to achieve substantially the same effect previously achieved with POWERPOINT.
4. The sound bites are added.
5. The completed presentation is stored and made available on an Internet web site. A URL is e-mailed anywhere and opened by any machine (PC or MAC) that has Internet access without the need for either POWERPOINT or FLASH.
6. A CD is burned with the URL address and a Read Only file of the Presentation/Script and given to the user.
7. MS-ACCESS is used as a simple data based program to gather specific information for specific applications or needs. A drop down menu is used on the contact page and is hidden behind the “contact or reply address.”

The present invention has many applications and is not confined or limited to the embodiments described herein. New uses will become manifest when a need arises e.g., political, retail and medical fields, association membership benefits, insurance applications, or the like.

University and school graduates can use the present invention to transmit transcripts, specific achievements, creative portfolios, sorority/fraternity affiliation, involvement in sports/music/community activities, and/or various academic highlights. Job candidates can use the present invention to transmit personalized resumes visualizing achievements, objectives, professional affiliations, volunteer experiences, personal interests, and specific little known facts which may favorably influence an employer.

Companies, armed forces, police/fire departments can use the present invention for recruitment purposes.

Thus, the present invention is applicable to new business development, employment opportunities, new product marketing, professional and personal networking, displaying design and other professional portfolios, art showings, audio/video trailers, tracking and instant messaging that is pleasurable for the viewer, opens doors of opportunity, is technologically current and is affordable.

With respect to new business development and new product marketing benefits, the present invention is operable to increase business, gain and maintain an audience's attention, build a referral network, share new techniques and products. Further, the present invention preferably generates interesting ideas, illustrates an organization's or individual's successes, shows teamwork, tracks growth, and provides employment opportunities. Moreover, the present invention is applicable for publishers, internal/external company communications, advertising, image building and so forth.

Although the present invention has been described in relation to particular embodiments thereof, many other variations and modifications and other uses will become apparent to those skilled in the art. It is preferred, therefore, that the present invention be limited not by the specific disclosure herein.

1. A method for providing a multimedia presentation, the method comprising:
defining a first multimedia presentation comprising at least image and text components, wherein the first multimedia presentation has a first file size and is viewable using a first presentation software application;
selecting the at least image and text components included in the first multimedia presentation and modifying at least one of the at least image and text component to reduce a respective size thereof;
defining a second multimedia presentation and providing the at least one reduced sized components into the second multimedia presentation; and
transmitting a message to a recipient enabling the recipient to access the second multimedia presentation, wherein the second multimedia presentation is accessible using at least one of a web browser software application and an e-mail software application, and wherein the second multimedia presentation appears substantially the same as the first presentation, and wherein the second multimedia presentation has a second file size that is smaller than the first file size.

2. The method of claim 1, wherein the second multimedia presentation is accessible over a communication network.

3. The method of claim 2, wherein the communication network is the Internet.

4. The method of claim 1, wherein the message is transmitted to the recipient via e-mail.

5. The method of claim 4, wherein the e-mail message contains a hyperlink to the second multimedia presentation or the second multimedia presentation, itself.

6. The method of claim 1, further comprising:
interviewing a user to extract information about the user and the type of presentation the user desires;
selecting user preferences, including at least one of background color, texture, text, animation, font type, and animation options;
developing a spoken script to be read and incorporated into the first multimedia presentation;
reading the script into a narration and adding the narration to the first multimedia presentation; and
evaluating the first multimedia presentation to determine whether frames are synchronized.

7. The method of claim 6, further comprising repeating at least one of the steps of selecting user preferences, developing a spoken script, reading the script, and evaluating the first multimedia presentation.

8. The method of claim 1, further comprising:
adjusting the isolated image components of the first multimedia presentation in order to reduce image size and pixel depth;
importing the reduced sized images into the second multimedia presentation;
creating an animation in the second multimedia presentation; and
assembling the second multimedia presentation.

9. The method of claim 8, further comprising repeating at least one of the steps of adjusting the isolated image components, importing the reduced sized images, creating an animation and assembling the second multimedia presentation.

10. The method of claim 1, wherein the first multimedia presentation is formatted as a MICROSOFT POWERPOINT presentation file, and the second presentation is formatted as a MACROMEDIA FLASH presentation file.

11. A method for providing a user with a multi-media presentation file developed over the Internet, the method comprising:
providing an Internet web site on an information processor;
providing in the Internet web site graphic screen controls on the Internet web site that enable a user to make choices representing the multimedia presentation desired by the user;
generating the multimedia presentation;
developing a spoken script to be incorporated into the multimedia presentation;
reading the script into a narration and adding the narration to the multimedia presentation;
implementing in the multimedia presentation the choices made by the user as a function of the graphic screen controls; and
storing the multimedia presentation in an accessible media for review by the user.

12. The method of claim 11, further comprising generating printed material from the multimedia presentation in response to requests for printed materials by the user.

13. The method of claim 12, wherein the printed material include at least a brochure.

14. The method of claim 11, further comprising packaging the multimedia presentation on a recordable medium, and sending the packaged multimedia presentation to the user.

15. The method of claim 14, further comprising charging the user a fee for at least one of providing the multimedia presentation over the Internet, providing the printed material to the user, and providing the packaged multimedia presentation to the user.
